(19) United States
(12) Patent Application Publication
(10) Pub. No.: US 2015/0178790 A1
(43) Pub. Date: Jun. 25, 2015

(54) User Engagement-Based Dynamic Reserve Price for Non-Guaranteed Delivery Advertising Auction

(71) Applicant: Yahoo! Inc., Sunnyvale, CA (US)

(72) Inventors: Xing Yi, Milpitas, CA (US); Yan, London (GB); Jean-Marc Langlois, Menlo Park, CA (US); Prabhakar Krishnamurthy, Pleasanton, CA (US)

(73) Assignee: Yahoo! Inc., Sunnyvale, CA (US)

(21) Appl. No.: 14/136,045

(22) Filed: Dec. 20, 2013

(51) Int. Cl. G06Q 30/02

(52) U.S. Cl. CPC G06Q 30/0275; G06Q 30/0273; G06Q 30/0202

(57) ABSTRACT

A system for adjusting reserve price for impressions of non-guaranteed delivery (“NDG”) advertising auctions includes a processor configured to retrieve a reserve price set by a publisher for an impression that is fillable by eligible advertisements to be streamed to users in a display content stream; and to retrieve user engagement information for users that engage the eligible advertisements. A statistical analyzer applies a statistical function to the user engagement information of an identified advertisement of the eligible advertisements, to generate a user engagement statistic for the identified advertisement related to a user engagement level. A reserve price adjuster dynamically adjusts the reserve price for the identified advertisement responsive to a value of the user engagement statistic, where the adjusted reserve price for the identified advertisement is different than the reserve price for at least another of the eligible advertisements based on different user engagement levels for each.

### RELATED APPLICATIONS

The present application relates to applications entitled: “USER ENGAGEMENT BASED NON-GUARANTEED DELIVERY PRICING,” (Atty. Dkt. 12729-1160), filed on Nov. 6, 2013, U.S. patent application Ser. No. 14/073,575, now U.S. Pat. No. ______; “PRIORITIZING ITEMS FROM DIFFERENT CATEGORIES IN A NEWS STREAM,” (Atty. Dkt. YAHOP209) filed on Aug. 28, 2013, U.S. patent application Ser. No. 14/012,932, now U.S. Pat. No. ______; “DWELL TIME BASED ADVERTISING,” (Atty. Dkt. YAHOP205) filed on Aug. 23, 2013, U.S. patent application Ser. No. 13/975,151, now U.S. Pat. No. ______; “DISPLAY TIME OF A WEB PAGE,” (Atty. Dkt. YAHOP189) filed on Mar. 15, 2013, U.S. patent application Ser. No. 13/843,433, now U.S. Pat. No. ______; each of which is incorporated by reference.

### BACKGROUND

This application relates to using online user engagement data, such as dwell time and click data with which to execute non-guaranteed delivery (NGD) advertisement (ad) auctions, and particularly to adjust reserve pricing of one or more NGD advertisements based on user engagement information of those advertisements.

Publishers reserve the right to not sell an impression (or advertising opportunity in a particular slot of a content stream) where advertisers' bids are below a certain threshold, also known as a reserve price, which publishers set in advance of the auction. If, however, at least one advertiser meets or exceeds the publisher's reserve price, the highest bidder wins the auction. In what is known as a second price reserve auction, the winning advertiser pays the second highest bid price. While the nature of the reserve price auction may be disclosed to advertisers, a publisher may or may not disclose the actual reserve price depending on whether or not the strategy of bidding slightly above reserve prices would be acceptable to the publisher.

### BRIEF DESCRIPTION OF THE DRAWINGS

The system may be better understood with reference to the following drawings and description. Non-limiting and non-exhaustive examples are described with reference to the following drawings. The components in the drawings are not necessarily to scale, emphasis instead being placed upon illustrating the principles of the system. In the drawings, like referenced numerals designate corresponding parts throughout the different views.

FIG. 1 is a block diagram of an example information system that includes an example non-guaranteed delivery (NGD) pricing server.

FIGS. 2A, 2B and 2C include example streams of advertisement items, content items, and data items in, respectively, a news property page, a homepage and a travel page.

FIG. 3 is a block diagram of an example NGD pricing server, along with select data flow, that can be implemented by one or more computing systems such as displayed in FIG. 1.

FIG. 4 includes example operations performed by the data collector of the NGD pricing server of FIG. 3.

FIG. 5 includes example operations performed by the statistical analyzer and the reserve price adjuster of the NGD pricing server of FIG. 3.

FIG. 6 includes further example operations performed by the statistical analyzer and the reserve price adjuster of the NGD pricing server of FIG. 3.

### DETAILED DESCRIPTION

Subject matter will now be described more fully hereinafter with reference to the accompanying drawings, which form a part hereof, and which show, by way of illustration, specific examples. Subject matter may, however, be embodied in a variety of different forms and, therefore, covered or claimed subject matter is intended to be construed as not being limited to any examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

Publishers can ensure coverage of their business costs of providing impressions (advertising display opportunities) by using a reserve price in auction bidding. In the traditional non-guaranteed delivery (“NDG”) auction, reserve price is statically set by publishers for the impressions the publishers plan to sell, and the reserve price is the same for all advertisers that run campaigns on the publisher's website, without considering any difference among advertisements, including performance. Publishers can leverage reserve prices in online advertising either as a tool for maximizing revenue or as an umbrella to protecting themselves from advertisers' “bidding more while bidding tiny” strategy. No publishers to date, however, have considered the use of user engagement metrics on advertisements to dynamically adjust a previously set reserve price in an exchange auction.

Disclosed is a system for adjusting reserve price for impressions auctioned in an NDG exchange. The system may include a processor configured to retrieve a reserve price set by a publisher for an impression that is fillable by eligible advertisements to be streamed to users in a display content stream. The processor may also retrieve user engagement information, such as dwell time, clicks, shares, likes, tweets and the like, for users that engage the eligible advertisements. A statistical analyzer may apply a statistical function to the user engagement information of an identified advertisement of the eligible advertisements, to generate a user engagement statistic, such as dwell time statistics, click statistics, share/tweet/like times' statistics, for the identified advertisement related to a user engagement level. A reserve price adjuster may dynamically adjust the reserve price for the identified advertisement responsive to a value of the user engagement statistic, where the adjusted reserve price for the identified advertisement is different than the reserve price for at least another of the eligible advertisements.

The user engagement statistic may be generated in different ways, including use of a probabilistic model that determines the probability that an advertisement will have a higher (or longer) user engagement than an expected (or average) user engagement for the identified advertisement. The user engagement statistic may also be a ratio of the user engagement mean of the identified advertisement compared to the user engagement mean of the eligible advertisements. The user engagement statistic may also be generated as a ratio of average short-click ratios (or bounce rates) of the eligible advertisements compared to the short-click ratio of the identified advertisement. Other models or functions may be applied as will become apparent with the more detailed discussion below.

The system may also apply the statistical function to the user engagement information of others of the eligible advertisements, to generate user engagement statistics for respective eligible advertisements. The system may then dynamically and selectively adjust the reserve price for each of those eligible advertisements responsive to values of respective user engagement statistics.

Accordingly, the disclosed system may compute different reserve prices for different advertisements bid on in the auction. By considering user engagement as a metric or statistic within this computation for purposes of adjusting the originally-set reserve price, publishers can let highly engaging advertisements participate and win more easily while bad quality or non-engaging advertisements can participate only at higher costs to the advertisers. In this way, publishers can obtain healthy short-term revenue (selling inventory of impressions) and better long-term engagement by users (and thus long-term revenue). The disclosed automatic adjustment of reserve prices is also a better approach for protecting publishers from the “biding less, bidding more strategy” in which some advertisers bid more times while always bidding small amounts of money to obtain a higher chance to find auctions with less competition. This occurs when such advertisers participate more frequently, endeavoring to win those auctions with little cost.

For example, in some situations advertisers may know when high-quality advertisements are not participating, such for example when within part of a bidding cycle where budgets are low or extinguished for the advertisers that bid the high-quality ads. The advertisers that game the exchange auction may try to bid more often and at lower prices in these cases, and win the auctions at a very low price or even for nothing (e.g., in a second-price auction where the second-highest bid is zero dollars).

An online information system places advertisements of advertisers within content services made available to end users, such as web pages, mobile applications (“apps”), TV apps, or other audio or visual content services. The advertisements are provided along with other content. The other content may include any combination of text, graphics, audio, video, or links to such content. The advertisements are conventionally selected based on a variety of criteria including those specified by the advertiser. The advertiser conventionally defines an advertising campaign to control how and when advertisements are made available to users and to specify the content of those advertisements.

Streams are becoming common in online presentation because they provide flexibility for content providers who source content items for the stream, advertisers who source advertising items for the stream and for the online provider that combines the content items and the advertising items to produce the stream. A stream allows any number and size and shape of content items and advertising items to be included in the stream. The elements of the stream may be sorted by relevance or by any suitable parameter. A stream also lowers the cognitive load on the viewer when processing information associated with different items of content or advertisements by removing the cognitive overhead associated with switching to a different visual format or perspective.

The stream may be viewed as a unified marketplace where content items and advertising items compete for placement or inclusion in the stream. The participants in the marketplace are advertisers who sponsor or provide the advertising items and content providers who sponsor or provide the content items. The stream and the marketplace may be hosted or managed by an online provider such as Yahoo! Inc. The online provider may also provide advertisements for its own products and services or its own content items for the stream.

Advertisers interact with equipment of the online provider to create or provide online advertisements. The online advertisements include advertising content stored in a database or other memory in association with identification of the advertiser and one or more bid amounts. The advertising content may include text or graphics or both and a link to a landing page to which the user's browser is redirected upon clicking the link. The bid amount represents an amount of money the advertiser will pay upon an event pertaining to the advertisement. The event may be an impression or viewing of the advertisement by a user, a click through or other selection of the advertisement by the user viewing the advertisement, or an action following viewing the advertisement such as providing credit card information or an email address. The bid amount may be used for determining position of the advertisement in the stream in a manner to be described below. The online advertisement may include other data as well including data defining how the advertisement will appear in the stream.

The content items include information on a topic that may be of interest to a user. This information may include a link to another web page providing more information about the topic and a summary of information about the topic. In some embodiments, a content provider will associate a bid amount with a content item. Similar to bid amounts for advertisements, the bid amount for a content item may be based on an impression, a click through, or another action. Also, the bid amount may be used for determining position of the content item in the stream in a manner to be described below. Alternatively, a software-based bidding agent may be employed to automatically bid on behalf of content items.

The content items and advertisement items are in competition for inclusion in the stream. The competition for slots in the stream may be cleared using a Generalized Second Price (GSP) auction mechanism. In a GSP auction, the highest bidder gets the first slot; the second highest bidder gets the second slot and so on. However, the highest bidder then pays the price bid by the second highest bidder. This is similar to a sponsored search marketplace although the bids in sponsored search are expressed differently and the competition in a sponsored search marketplace is only between advertisements.

In one embodiment, an advertiser provides targeting predicates, an advertisement snippet and a bid. In some embodiments, the advertiser can provide a budget across multiple triples, referred to as targeting triples. Targeting predicates may be based on any type of market segment of interest to advertisers, including in one example, demographic markets, market segments based gender or age, behavioral segments based on user profile information, or geographic markets. The bids may be cost per click (CPC) bids, cost per impression (CPM) bids or cost per action (CPA) bids. The online provider may choose not to support all bid types in all marketplaces.

What advertisers are allowed to bid for in large part determines their bidding behavior. For the online provider who manages the unified marketplace, there is a trade-off between allowing advertisers to bid for very specific targets versus allowing advertisers to bid for broader targets.

The online provider may prefer markets that are thick with many competing advertisers to thin markets with few advertisers. The thicker the market, the greater the potential for increased revenue to the online provider. However, many advertisers are very interested in specific types of user. These narrow-focused users will likely stay out of the marketplace unless they are allowed to bid more narrowly. Broad targets lower the average value an advertiser derives since their advertisements may be shown to users who may not be interested in their products. Lower expected values lead to lower bids.

Some of these trade-offs can be mitigated by pricing for performance, by using excellent scoring algorithms and by preventing advertisements of low relevance from showing in the stream. Pricing for performance implies charging only when a user responds to an advertisement. Advertisers would prefer to pay only when users convert, such as by paying for a product or service. However, defining and tracking conversions and estimating conversion rates may be difficult to do reliably, so marketplace operators prefer charging by clicks, which are more easily tracked and estimated. Charging per click can pose challenges. For example, not all clicks from users convert into sales for an advertiser. With too many clicks that do not result in a conversion, a low quality score for the advertisement may result.

Broad targeting requires precise scoring methods to maintain good user and advertiser experiences. Scoring is the process of assigning a value to an advertisement or content item which value can then be used for determining which item should be included in the stream. This precise scoring may require that the online provider examine not just the advertisement snippet but also the contents of the landing page. In some embodiments, an advertisement may include additional information such as metadata that is automatically collected or manually provided by the advertiser and used as signals to the scoring function.

Broad targeting may also add a difficulty in pricing for CPC advertisements. In pricing the advertisement, one may distinguish between the quality of the match between a keyword and a search term and the quality of the advertisement. The online operator may choose to discount advertisers for poor quality matches, which are the responsibility of the operator of the online marketplace that does the matching. The online operator may choose to charge a premium for poor quality advertisements, which are the responsibility of the advertiser.

An exemplary system will now be described in which aspects of the unified marketplace for advertisement items and content items may be illustrated and described. Further details and optional embodiments will be provided in connection with the drawings.

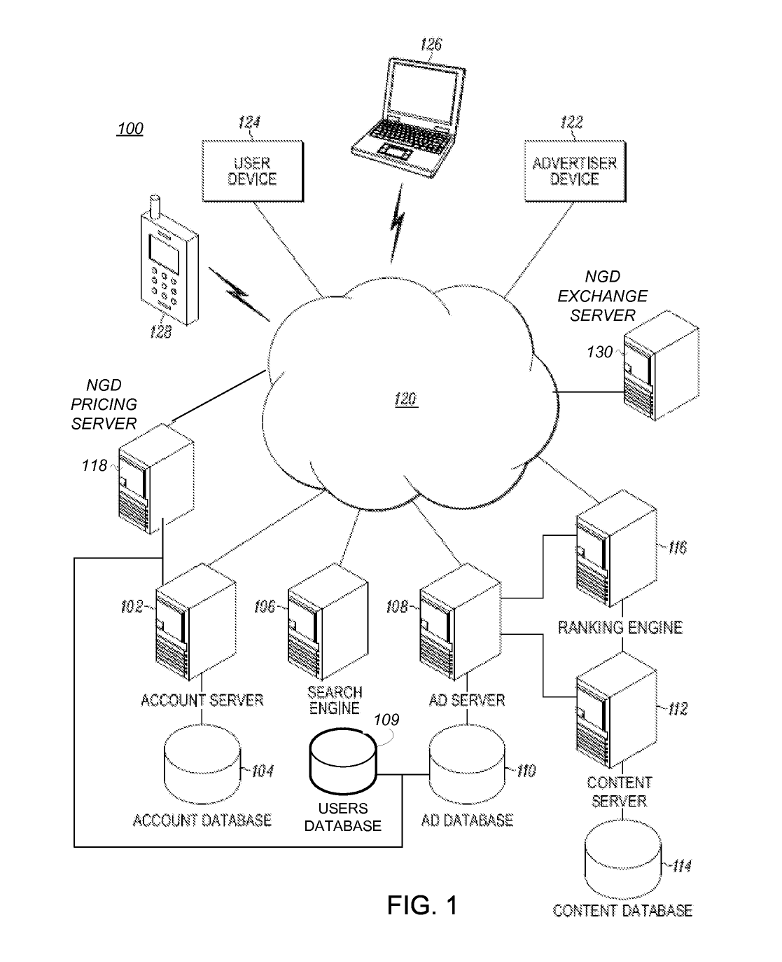

FIG. 1 is a block diagram of an online information system 100. The online information system 100 in the exemplary embodiment of FIG. 1 includes an account server 102, and account database 104, a search engine 106, an advertisement (ad) server 108, a users database 109, an ad database 110, a content database 114, a content server 112, a ranking engine 116, a non-guaranteed delivery (NGD) pricing server 118, and an NGD exchange server 130. The online information system 100 may be accessible over a network 120 by one or more advertiser devices such as advertiser device 122 and by one or more user devices such as user device 124. For this reason the online information system 100 may also be referred to as a NGD network system 100.

In various examples of such an online information system, users may search for and obtain content from sources over the network 120 or from the content database 114. Advertisers may provide advertisements for placement on web pages and other communications sent over the network to user devices such as the user device 124. The online information system in one example is deployed and operated by an online provider such as Yahoo! Inc.

The account server 102 stores account information for advertisers. The account server 102 is in data communication with the account database 104. Account information may include one or more database records associated with each respective advertiser. Any suitable information may be stored, maintained, updated and read from the account database 104 by the account management server 102. Examples include advertiser identification information, advertiser security information such as passwords and other security credentials, and account balance information.

The account server 102 may be implemented using any suitable device. The account management server 102 may be implemented as a single server, a plurality of servers, or any other type of computing device known in the art. Preferably, access to the account server 102 is accomplished through a firewall, not shown, which protects the account management programs and the account information from external tampering. Additional security may be provided via enhancements to the standard communications protocols such as Secure HTTP or the Secure Sockets Layer.

The account server 102 may provide an advertiser front end to simplify the process of accessing the account information of an advertiser. The advertiser front end may be a program, application or software routine that forms a user interface. In one particular embodiment, the advertiser front end is accessible as a web site with one or more web pages that an accessing advertiser may view on an advertiser device such as advertiser device 122. The advertiser may view and edit account data and advertisement data using the advertiser front end. After editing the advertising data, the account data may then be saved to the account database 104.

The search engine 106 may be a computer system, one or more servers, or any other computing device known in the art. Alternatively, the search engine 106 may be a computer program, instructions, or software code stored on a computer-readable storage medium that runs on a processor of a single server, a plurality of servers, or any other type of computing device known in the art. The search engine 106 may be accessed, for example, by user devices such as the user device 124 operated by a user over the network 120. The user device 124 communicates a user query to the search engine 106. The search engine 106 locates matching information using any suitable protocol or algorithm and returns information to the user device 124. The search engine 106 may be designed to help users find information located on the Internet or an intranet. In a particular example, the search engine 106 may also provide to the user device 124 over the network 120 a web page with content including search results, information matching the context of a user inquiry, links to other network destinations or information and files of information of interest to a user operating the user device 124, as well as a stream of content items and advertisement items selected for display to the user.

The search engine 106 may enable a device, such as the user device 124 or any other client device, to search for files of interest using a search query. Typically, the search engine 106 may be accessed by a client device via one or more servers or directly over the network 120. The search engine 106 may, for example, in one illustrative embodiment, comprise a crawler component, an indexer component, an index storage component, a search component, a ranking component, a cache, a profile storage component, a logon component, a profile builder, and one or more application program interfaces (APIs). The search engine 106 may be deployed in a distributed manner, such as via a set of distributed servers, for example. Components may be duplicated within a network, such as for redundancy or better access.

The ad server 108 operates to serve advertisements to user devices such as the user device 124. Advertisements include data defining advertisement information that may be of interest to a user of a user device. An advertisement may include text data, graphic data, image data, video data, or audio data. An advertisement may further include data defining one or more links to other network resources providing such data. The other locations may be other locations on the Internet, other locations on an intranet operated by the advertiser, or any access.

For online information providers, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior. This sort of information, including click data related to user behavior with respect to the advertisements may be stored in the users database 109, which may be combined with the advertisements database 110 in one embodiment.

Another approach includes profile-type advertisement targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

Yet another approach includes targeting based on content of a web page requested by a user. Advertisements may be placed on a web page or in association with other content that is related to the subject of the advertisements. The relationship between the content and the advertisement may be determined in any suitable manner. The overall theme of a particular web page may be ascertained, for example, by analyzing the content presented therein. Moreover, techniques have been developed for displaying advertisements geared to the particular section of the article currently being viewed by the user. Accordingly, an advertisement may be selected by matching keywords/and or phrases within the advertisement and the web page. One exemplary system and method are disclosed in U.S. patent application Ser. No. 13/836,052, filed Mar. 15, 2013, pending, entitled Efficient Matching of User Profiles with Audience Segments for Audience Buy. This application is incorporated herein in its entirety by this reference.

The ad server 108 includes logic and data operative to format the advertisement data for communication to the user device. The ad server 108 is in data communication with the ad database 110. The ad database 110 stores information including data defining advertisements to be served to user devices. This advertisement data may be stored in the ad database 110 by another data processing device or by an advertiser. The advertising data may include data defining advertisement creatives and bid amounts for respective advertisements.

For example, the advertising data may be formatted to an advertising item, which may be included in a stream of content items and advertising items provided to a user device. The formatted advertising items are specified by appearance, size, shape, text formatting, graphics formatting and included information, which may all be standardized to provide a consistent look for all advertising items in the stream. At least some advertising items may have an associated bid amount and may be considered to be revenue-generating items. The ad server 108 then provides the advertising items to other network devices such as the ranking engine 116.

Further, the ad server 108 is in data communication with the network 120. The ad server 108 communicates advertisement data and other information to devices over the network 120. This information may include advertisement data communicated to a user device. This information may also include advertisement data and other information communicated with an advertiser device such as the advertiser device 122. An advertiser operating an advertiser device may access the ad server 108 over the network to access information including advertisement data. This access may include developing advertisement creatives, editing advertisement data, deleting advertisement data, setting and adjusting bid amounts and other activities.

The ad server 108 may provide an advertiser front end to simplify the process of accessing the advertising data of an advertiser. The advertiser front end may be a program, application or software routine that forms a user interface. In one particular embodiment, the advertiser front end is accessible as a web site with one or more web pages that an accessing advertiser may view on the advertiser device. The advertiser may view and edit advertising data using the advertiser front end. After editing the advertising data, the advertising data may then be saved to the ad database 110 for subsequent communication in advertisements to a user device.

The advertisement server 108 may be a computer system, one or more servers, or any other computing device known in the art. Alternatively, the advertisement server 108 may be a computer program, instructions and/or software code stored on a computer-readable storage medium that runs on a processor of a single server, a plurality of servers, or any other type of computing device known in the art.

The content server 112 is in data communication with the content database 114, the ad server 108 and the ranking engine 116. The content server 112 may access information about content items from either the content database 114 or from another location accessible over the network 120. The content server 112 communicates data defining content items and other information to devices over the network 120. This information may include content data communicated to a user device. This information may also include content data and other information communicated with a content provider operating a content provider device. A content provider operating a content provider device may access the content server 112 over the network 120 to access information including content data. This access may include developing content items, editing content items, deleting content items, setting and adjusting bid amounts and other activities.

The content server 112 may provide a content provider front end to simplify the process of accessing the content data of a content provider. The content provider front end may be a program, application or software routine that forms a user interface. In one particular embodiment, the content provider front end is accessible as a web site with one or more web pages that an accessing content provider may view on the content provider device. The content provider may view and edit content data using the content provider front end. After editing the content data, the content data may then be saved to the content database 114 for subsequent communication to a user device.

The content server 112 includes logic and data operative to format content data and other information for communication to the user device. For example, the content data may be formatted to a content item that may be included in a stream of content items and advertisement items provided to a user device. The formatted content items are specified by appearance, size, shape, text formatting, graphics formatting and included information, which may all be standardized to provide a consistent look for all content items in the stream. In some embodiments, the content items have an associated bid amount that may be used for ranking or positioning the content items in a stream of items presented to a user device. In other embodiments, the content items do not include a bid amount or the bid amount is not used for ranking the content items. Such content items may be considered to be non-revenue generating items. The content server 112 then provides the content items to other network devices such as the advertising server 108 and the ranking engine 116.

The ranking engine 116 is in data communication with the ad server 108, the ad database 110, the content server 112 and the content database 114. The ranking engine 116 is configured to identify items to be included in a stream of content items and advertising items to be provided to a user device such as the user device 124. The ranking engine 116 may thus be configured to determine which advertising items and which content items are qualified to be included in the stream and to score and to order respective advertising items and respective content items in the stream.

In one embodiment, the ranking engine 116 is configured to calculate a ranking score for each of a plurality of advertising items using bid values retrieved from the ad database 110. The ranking engine 116 is further configured to calculate a ranking score for each of a plurality of content items using bid values obtained from the content database 114. The ranking engine 116 may use other information available from the ad server 108, the ad database 110, the content server 112 and the content database 114 as well as the account database 104 when determining the ranking scores.

The account server 102, the search engine 106, the ad server 108, the content server 112, the ranking engine 116, the NGD pricing server 118 and NGD exchange server 130 may be implemented as any suitable computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

The account server 102, the search engine 106, the ad server 108, the content server 112, the ranking engine 116, the NGD pricing server 118 and the NGD exchange server 130 may be implemented as online server systems or may be in communication with online server systems. An online server system may include a device that includes a configuration to provide content via a network to another device including in response to received requests for page views. An online server system may, for example, host a site, such as a social networking site, examples of which may include, without limitation, Flicker, Twitter, Facebook, LinkedIn, or a personal user site (such as a blog, vlog, online dating site, etc.). An online server system may also host a variety of other sites, including, but not limited to business sites, educational sites, dictionary sites, encyclopedia sites, wikis, financial sites, government sites, etc.

An online server system may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may not be under common ownership or control with the ad server 108, the content server 112 or the ranking engine 116.

The network 120 may include any data communication network or combination of networks. A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network such as the network 120. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

The advertiser device 122 includes any data processing device that may access the online information system 100 over the network 120. The advertiser device 122 is operative to interact over the network 120 with the account server 102, the search engine 106, the ad server 108, the ranking engine 116, content servers and other data processing systems. The advertiser device 122 may, for example, implement a web browser for viewing web pages and submitting user requests. The advertiser device 122 may communicate data to the online information system 100, including data defining web pages and other information. The advertiser device 122 may receive communications from the online information system 100, including data defining web pages and advertising creatives.

In some embodiments, content providers may access the online information system 100 with content provider devices that are generally analogous to the advertiser devices in structure and function. The content provider devices provide access to content data in the content database 114, for example.

The user device 124 includes any data processing device that may access the online information system 100 over the network 120. The user device 124 is operative to interact over the network 120 with the search engine 106. The user device 124 may, for example, implement a web browser for viewing web pages and submitting user requests. A user operating the user device 124 may enter a search request and communicate the search request to the online information system 100. The search request is processed by the search engine and search results are returned to the user device 124. In other examples, a user of the user device 124 may request data such as a page of information from the online information processing system 100. The data instead may be provided in another environment such as a native mobile application, TV application, or an audio application. The online information processing system 100 may provide the data or re-direct the browser to another web site. In addition, the ad server may select advertisements from the ad database 110 and include data defining the advertisements in the provided data to the user device 124.

The advertiser device 122 and the user device 124 operate as a client device when accessing information on the online information system 100. A client device such as the advertiser device 122 and the user device 124 may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. In the example of FIG. 1, both laptop computer 126 and smartphone 128 may be operated as either an advertiser device or a user device.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example. A client device such as the advertiser device 122 and the user device 124 may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games. The foregoing is provided to illustrate that claimed subject matter is intended to include a wide range of possible features or capabilities.

The NGD exchange server 130 may be configured to conduct real-time auctions with advertisements being submitted by advertisers as advertising display opportunities (impressions) become available to insert advertisements into slots (or locations) of a content stream, as will be discussed below. The NGD exchange server 130 may deliver the advertisements provided by advertisers having the highest bids to the content stream, and potentially with additional consideration of other factors, such as relevancy, taking into account the context of the advertisements adjacent or near to content that is related to the advertisements.

The NGD pricing server 118 may obtain data from the advertisements database 110 (such as targeting predicates and other criteria) and from the users database 109 such as click data (user engagement activity on identified advertisements) and devices 124, 126 and 128 from which the users are engaging identified advertisements. The NGD pricing server 118 may perform additional analysis such as determining short-click ratios and user engagement information for the advertisements with reference to users based on the obtained data, and then adjust the reserve price for at least some of the advertisements based on the analysis, so as to generate more revenue from low-bidding advertisers with low-quality ads. The determination of how to adjust the reserve price will be explained in more detail.

In this way, publishers can obtain healthy short term revenue (selling inventory of impressions) and better users' long term engagement (and thus long-term revenue). The disclosed automatic adjustment of reserve prices is also a better approach for protecting publishers from the “biding less, bidding more frequently strategy” in which some advertisers bid more times while always bidding small amount of money.

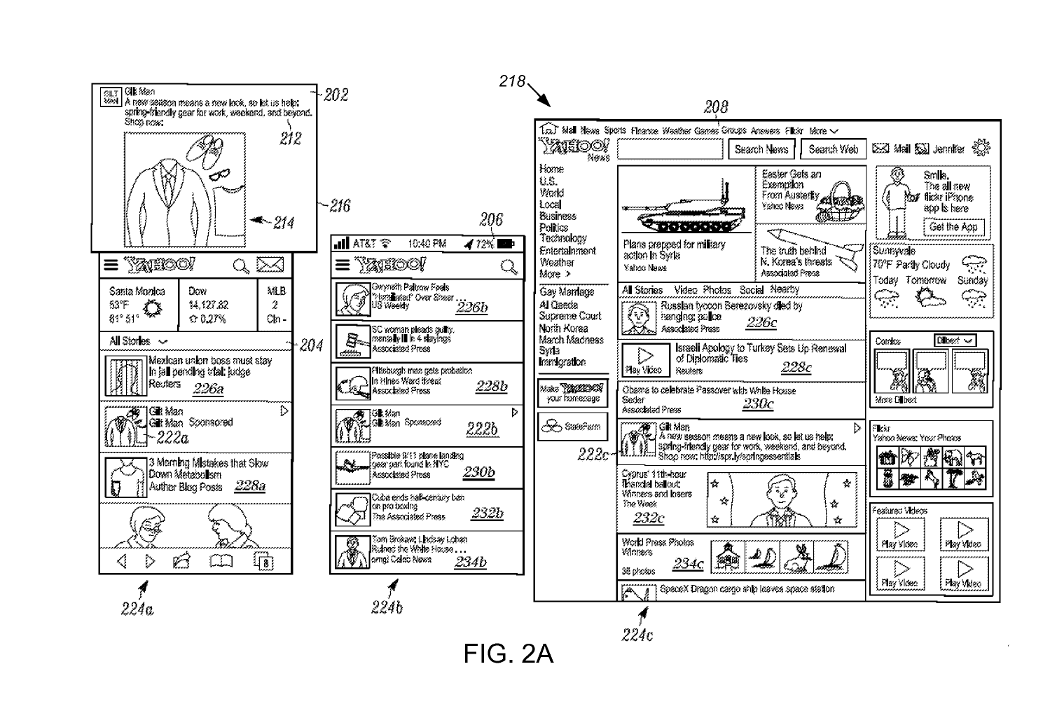

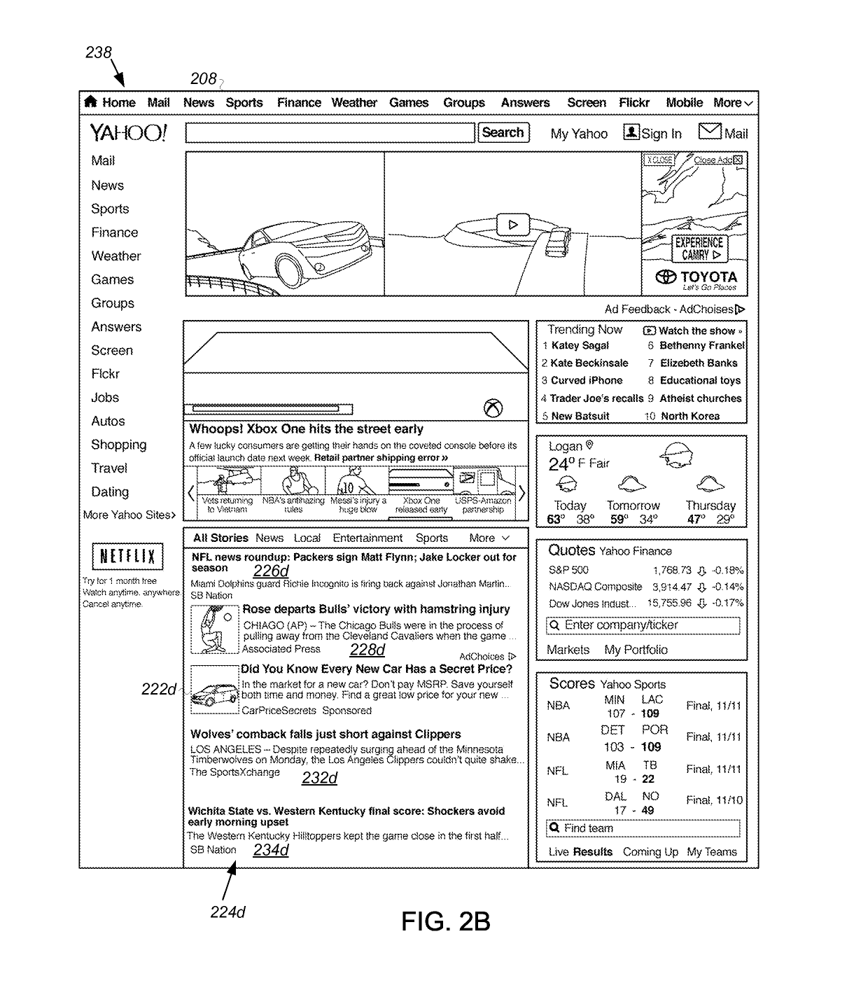

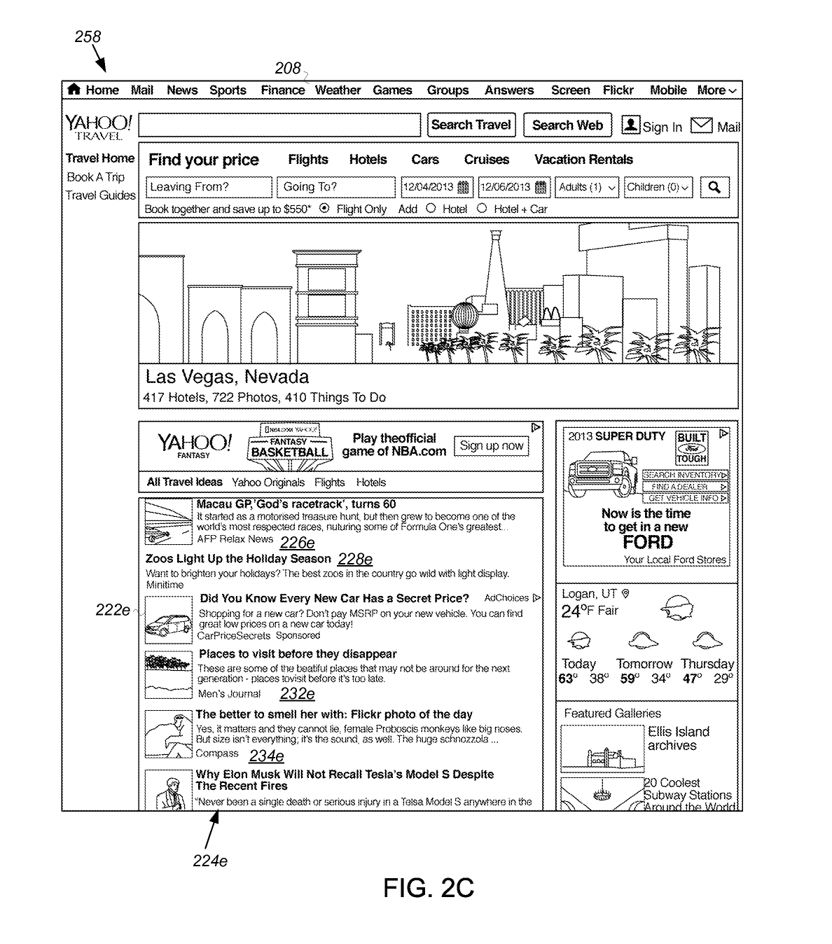

FIG. 2A illustrates streams of content items and data items displayed on selected user devices. In FIG. 2A, a display advertisement 202 is illustrated as displayed on a variety of displays including a mobile web device display 204, a mobile application display 206 and a personal computer display 208. The mobile web device display 204 may be shown on the display screen of a mobile handheld device such as a smartphone. The mobile application display 206 may be shown on the display screen of a portable device such as a tablet computer. The personal computer display 208 may be displayed on the display screen of a personal computer (PC).

The display ad 202 is shown in FIG. 2A formatted for display on a user device but not as part of a stream to illustrate an example of the contents of such a display ad. The display ad 202 includes text 212, graphic images 214 and a defined boundary 216. The display ad 202 is developed by an advertiser for placement on a web page sent to a user device operated by a user. The display ad 202 may be placed in a wide variety of locations on the web page. However, the defined boundary 216 and the shape of the display advertisement must be matched to a space available on a web page. If the space available has the wrong shape or size, the display ad 202 may not be useable.

To overcome these requirements and limitations, the display ad 202 may be reformatted or alternately formatted for inclusion in a stream of content items and advertising items including a stream advertisement incorporating contents of the display ad 202.

In these examples, the display advertisement is shown as a part of streams 224a, 224b, and 224c. The streams 224a, 224b, 224c include a sequence of items displayed, one item after another, for example, down a web page viewed on the mobile web device display 204, the mobile application display 206 and the personal computer display 208. The streams 224a, 224b, 224c may include any type of items. In the illustrated example, the streams 224a, 224b, 224c includes content items and advertising items. For example, stream 224a includes content items 226a and 228a along with advertising item 222a; stream 224b includes content items 226b, 228b, 230b, 232b, 234b and advertising item 222b; and stream 224c includes content items 226c, 228c, 230c, 232c and 234c and advertising item 222c. Each of the streams 224a, 224b, 224c may include any number of content items and advertising items. In one embodiment, the streams 224a, 224b, 224c may be arranged to appear to the user to be an endless sequence of items so that as a user of a user device on which one of the streams 224a, 224b, 224c is displayed scrolls the display, a seemingly endless sequence of items appears in the displayed stream.

The content items positioned in any of streams 224a, 224b, 224c may include news items, business-related items, sports-related items, etc. Further, in addition to textual or graphical content, the content items of any stream may include other data as well, such as audio and video data or applications. Each content item may include text, graphics, other data, and a link to additional information. Clicking or otherwise selecting the link re-directs the browser on the user's device to a web page referred to as a landing page that contains the additional information.

Stream advertisements like the advertising items 222a, 222b, and 222c may be inserted into the stream of content, supplementing the sequence of related items, providing a more seamless experience for end users. Similar to content items, the advertising items may include textual or graphical content as well as other data such as audio and video data or applications. Each advertising item 222a, 222b, and 222c may include text, graphics, other data, and a link to additional information. Clicking or otherwise selecting the link re-directs the browser on the user's device to a web page referred to as a landing page.

While the exemplary streams 224a, 224b, 224c are shown with a single visible advertising item 222a, 222b, 222c, respectively, any number of advertising items may be included in a stream of items. Conventionally, it has been known to position the advertising items at fixed locations. For example, in one conventional system, it was known to position an advertising item at the third item in the stream, counting from the top, at the sixteenth item in the stream and at every thirteenth item in the stream thereafter. That is, in the conventional system, advertisements are located in pre-defined slots in the stream. Slotting of the advertisements is the same for all users under all conditions. In this regard, advertisements and content items are complements in the stream. If a content item is not placed at a designated slot in the stream, an advertisement is placed in that slot.

In accordance with one aspect of the illustrated embodiment, slotting of advertisements in a stream is made dynamic. Any slot in the stream is subject to competition between advertising items and content items. A score is determined for each respective item. The scores for the advertising items and the content items are made commensurate so that advertising items and content items may be ranked against each other and the ranking used to populate the stream. Techniques for ranking the advertising items and content items are discussed in further detail below.

FIG. 2A is a news page 218 of Yahoo, Inc. FIG. 2B is a homepage 238 of Yahoo, Inc., and FIG. 2C is a travel page 258 of Yahoo, Inc. These are also referred to as Yahoo! properties and may include different content streams 224c, 224d and 224e, respectively. The homepage 238 of FIG. 2B and the travel page of FIG. 2C may also be displayed on a variety of displays including a mobile web device display 204, a mobile application display 206 and a personal computer display 208 as is shown on the news page 218 of FIG. 2A.

The content stream 224d (FIG. 2B) may also include content items 226d, 228d, 232d and 234d interweaved with one or more advertisement item 222d. The content stream 224e (FIG. 2C) may also include content items 226e, 228e, 232e and 234e interweaved with one or more advertisement item 222e. The content and advertisement items may differ across different properties in matching more closely with the themes of respective properties, with targeting users that would be interested in respective properties or for other reasons. The result is that different contexts are produced in the combination of the advertisement being displayed, the device on which the advertisement is displayed, and the product or property in which the advertisement is streamed within a content stream. User engagement information may be gathered with reference to the content and advertisement items across these different display contexts.

With further reference to FIG. 1, the NGD pricing server 118 may price one or more NGD content items, such as NGD advertisements, at an optimal price according to user interactions with the item(s) or content associated and/or linked with the item(s). Such user interactions, including dwell times, clicks, sharing of content, likes, and tweets, for example, can define user engagement with the item(s). Hereinafter, user engagement with the item(s) will be referred to as “user engagement.”

The NGD pricing server 118 may be part of an NGD exchange server 130 or may be a distributed computing system within a NGD network system 100. The user engagement may be associated with Internet browsing session information, such as information on dwell time and clicks of online content items, which may include but not be limited to informational and commercial advertisements (“advertisements”) items. The NGD pricing can employ various techniques, including the technologies described herein. Also, other types of marketing optimizers may use the technologies and techniques described herein. For example, even though the methods and technologies described herein are especially useful for NGD content pricing, such methods and technologies can be used by any type of content pricing system, including systems that price guaranteed delivery content.

The functions described herein can apply to any type of content, such as an online advertisement within a session of a webpage view or consumed while viewing of an online stream. For example, the online advertisement can be viewed within a mobile webpage or mobile content stream. A view or any other type of user engagement or interaction can be quantified through a dwell time of a page or a stream. For the purposes of this disclosure, user engagement may be the time during which a user interacts with a content item or an advertisement. For example, user engagement can be measured as the time between two interactions with content, such as two interactions with an advertisement on a webpage or within an online content stream.

In an example, the NGD pricing module may include a data-driven tool for NGD pricing. This tool may enhance a CPC based pricing model with user engagement information as input to improve revenue generated from online advertisements and other types of online content. Besides improving revenue generated by an item of content, the enhancement is meant to increase user engagement with the item.

The price-per-thousand impressions (eCPM) of CPC pricing models in an NGD market may be computed by Formula 1.

eCPM(CPC)=p(click|impression,content)*b, (1)
wherein p(click|impression,content) is the probability that an impression will result in a click, and
b is a bid or a selected price for an impression of a content item.

Formula 1 uses a probability that an impression will result in a click. An alternative example can use a probability that a certain dwell time will occur. Also, Formula 1 could be modified to consider other forms of user engagement or interaction with online content.

Using dwell time, for example, instead of clicks may have advantages. For example, dwell time may be a more accurate measure of actual user engagement with a content item or ad in some instances. For example, if a user is taking the time to read or view the content item, as opposed to merely clicking on it, that item may be more engaging. In exemplary embodiments, user engagements and/or impressions resulting from clicks may be considered in determining eCPM.

To enhance the effectiveness of eCPM with respect to actual user engagement or interaction, the NGD pricing server 118 may use dwell time information. Dwell time may be used solely or in combination with other measurements of user interaction or engagement, and the NGD pricing server 118 may also use dwell time based user engagement to adjust an eCPM based bid for a CPC auction. Advertisements with short dwell times may be discounted, while advertisements with long dwell times may have a higher eCPM based bids. Whether a dwell time is considered long or short may depend on context (such as context with respect to an associated campaign, a device displaying the ad, and the type of medium the advertisement is delivered). For a simple example, for article content items, the average dwell time may correlate to the length of the article. A long article may have higher short and long dwell time thresholds. Also, conservative fixed thresholds can be used for each context, or machine-learning techniques to learn dynamic threshold functions in different contexts can be leveraged to determine engagement thresholds.

In an example, thresholds can be determined according to a mean, median, and/or mode of engagement, such as a mode dwell time for an advertisement campaign. The threshold can be set at a point after the mean, median, or mode. Also, a dwell time distribution or distributions for a determined baseline advertisement or webpage can be used as a threshold as well.

Also, from using dwell time or another form of quantifying user engagement or interaction, balance between driving long term user engagement with a content item and generating revenue may be achieved by allowing more engaging advertisements to win an auction. This encourages advertisers to produce more engaging advertisements. It also benefits a publisher by providing a way to evaluate advertisements immediately from samples of user sessions with the streaming content, and determine changes to or termination of poor performing advertisements. Adding real-time functionality to the NGD pricing allows for determining such changes to or termination of advertisements sooner rather than later.

Additionally or alternatively, the eCPM of a content item (such as an ad) can be automatically adjusted by the NGD pricing server 118, even with a low click through rate (CTR) associated with the item and/or small samplings of session data associated with the item.

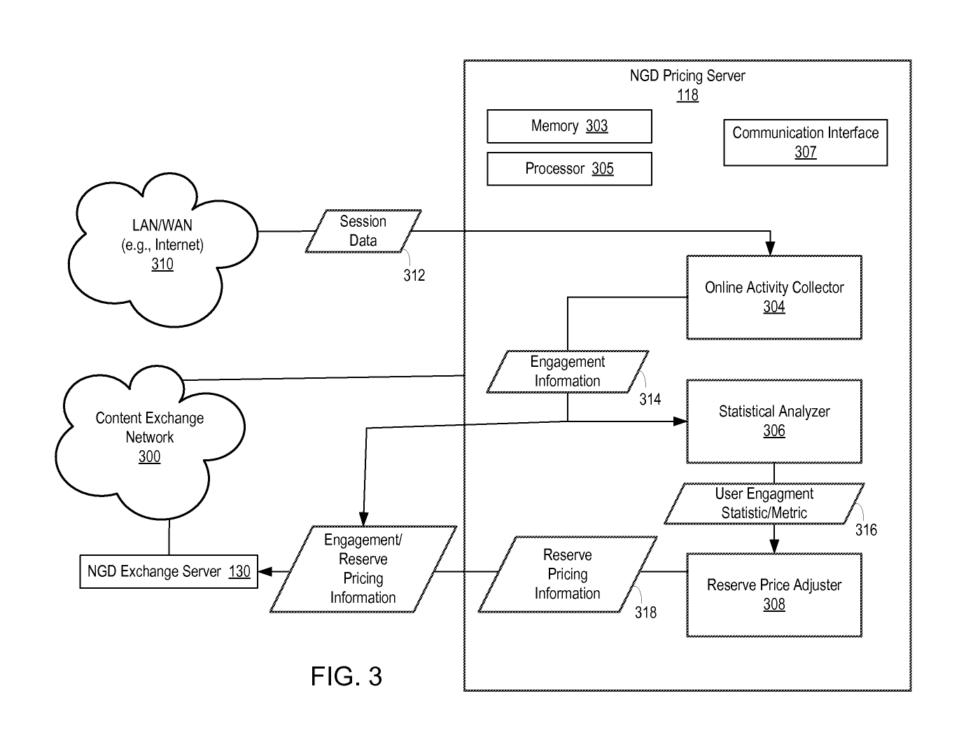

FIG. 3 is a block diagram of an example NGD pricing server 118, along with select data flow. The NGD pricing server 118 may be executed within the NGD exchange server 130 or as a distributed system across two or more of the servers disclosed in FIG. 1, and as part of a content exchange network 300. The NGD pricing server 118 may include memory 303, a processor 305 and a communication interface 307 to facilitate processing and communication through the network 120. The NGD pricing server 118 may further include an online activity collector 304, a statistical analyzer 306 and a reserve price adjuster 308, all of which are executable by the processor 305, and be coupled with the account server 102, the ad database 110 and the users database 109 (FIG. 1).

The processing of the NGD pricing server 118 may be integrated into and be in communication with the content exchange network 300, such as an NGD advertisement exchange, so that historical and/or real-time user engagement and interaction data (such as dwell time and click information) can be used for enhancing pricing of content, such as pricing NGD advertisements (and corresponding reserve prices) competing for slots in an auction system. The NGD pricing server 118 may leverage user engagement or interaction to manually and/or automatically adjust content pricing or valuation, such as automatically adjusting reserve prices for NGD content, especially for advertisement of the NGD auction.

The online activity collector 304 may be communicatively coupled to a LAN/WAN 310 (such as network 120 of FIG. 1) that may include the Internet. From the LAN/WAN 310, the online activity collector 304 may receive online user session data 312, such as web browsing session data. The online activity collector 304 can then determine and communicate user interaction (or dwell time) information 314 to the statistical analyzer 306 and the NGD exchange server 130. The statistical analyzer 306 may determine a dwell time statistic (or metric) 316 according to application of a statistical function to the dwell time or engagement information 314. The dwell time statistic 316 may reflect user engagement levels with respect to online content and advertisement items.

From the dwell time statistic 316, the reverse price adjuster 308 may dynamically adjust the reserve price for respective advertisements such as to favor (with lower reserve prices) those advertisements with higher user engagement, improving both short and long-term revenue streams.

The NGD pricing server 118 may send the reserve pricing information 318, including adjusted reserve prices for advertisements or creatives, to the NDG exchange server, along with the user engagement information 314 aggregated by the online activity collector 304 in some cases.

In an example, the online activity collector 304 may include a system of collecting stream advertisements per creative per click event dwell time information. In such an example, this module can collect such information via systems and methods described in “DISPLAY TIME OF A WEB PAGE,” (Atty. Dkt. YAHOP189) filed on Mar. 15, 2013, U.S. Ser. No. 13/843,433, now U.S. Pat. No. ______, or other systems and methods, to compute per-item per-user dwell time information, for example.

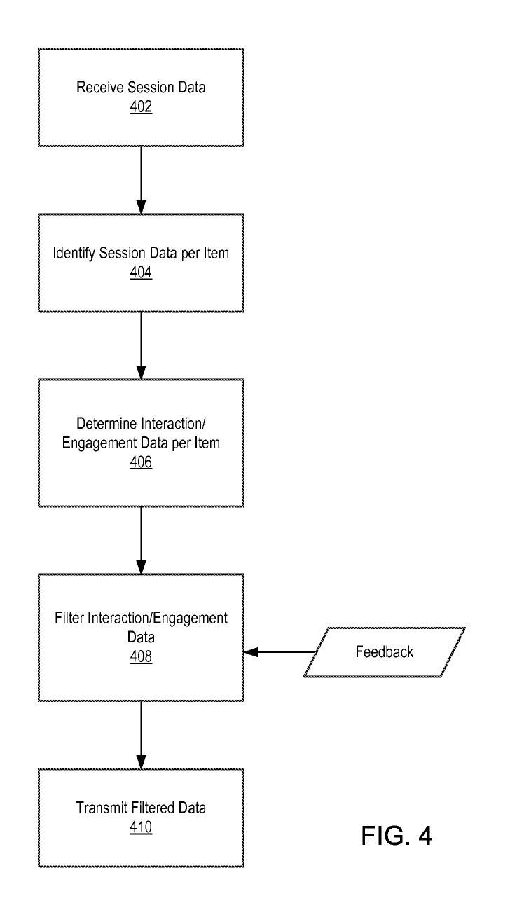

With additional reference to FIG. 4, functionality of the online activity collector 304 is described in more detail. At 402, the online activity collector 304 may receive user session data from a network, such as the LAN/WAN 310. The session data may be associated with NGD content and can include click and dwell time information or other types of user engagement activities, such as click and dwell time information associated with a creative. A creative may include at least one of non-advertisement content item, an advertisement item, a streamed item, a page displayed item, or any combination thereof. For example a creative can be a group of items or a single item, such as one or more of the advertisement items, contents items, and data items of FIG. 2.

At 404, the online activity collector 304 may identify session data associated with a content item broadcasted by the network according to a corresponding identifier. Session data corresponding to a content item may be associated with the content item through metadata within a tag, a header, or any other known forms of implementing metadata based data associations. Each content item may be associated with a unique identifier. At 406, the online activity collector 304 can determine user interaction information associated with the content item, such as dwell times and clicks associated with the item. The content item may be any type of online content item, including any type of advertisement and non-advertisement item.

At 408, the online activity collector 304 may filter user interaction information. The filtering of this information can be according to feedback from the statistical analyzer 306 or other aspects or modules associated with the NGD pricing server. At 410, the filtered interaction information may be transmitted to other components of the NGD pricing server 118 such as to the statistical analyzer 306.

Proposed is the use of a user engagement signal as a long-term revenue proxy and for adjustment of reserve price to ensure protection of user experience for publishers, while monetizing products provided by publishers (which can include different streams of content). The relationship between reserve price adjustment and user engagement signal may be linear or nonlinear. Publishers may quantify the value of the user experience by the amount of revenue brought by showing low quality advertisements, which should exceed the cost of any long-term user experience.

Publishers may specify two things before execution of an auction, including (1) a baseline reserve price (RP) for each impression opportunity where different stream slots may have different baseline reserve prices according to respective rank positions; and (2) the function (F) (or mapping) between the user engagement signal level (e) and the reserve price adjustment factor (p). Below are described different ways this function (F) may be implemented.

In an example, the statistical analyzer 306 may include statistical distribution analysis aspects, which can compute dwell time and other user engagement distributions associated with the creative. Such analysis can use the raw session data collected by the online activity collector 304 or the information filtered by the online activity collector 304 (such as the data filtered at 408 and transmitted at 410).

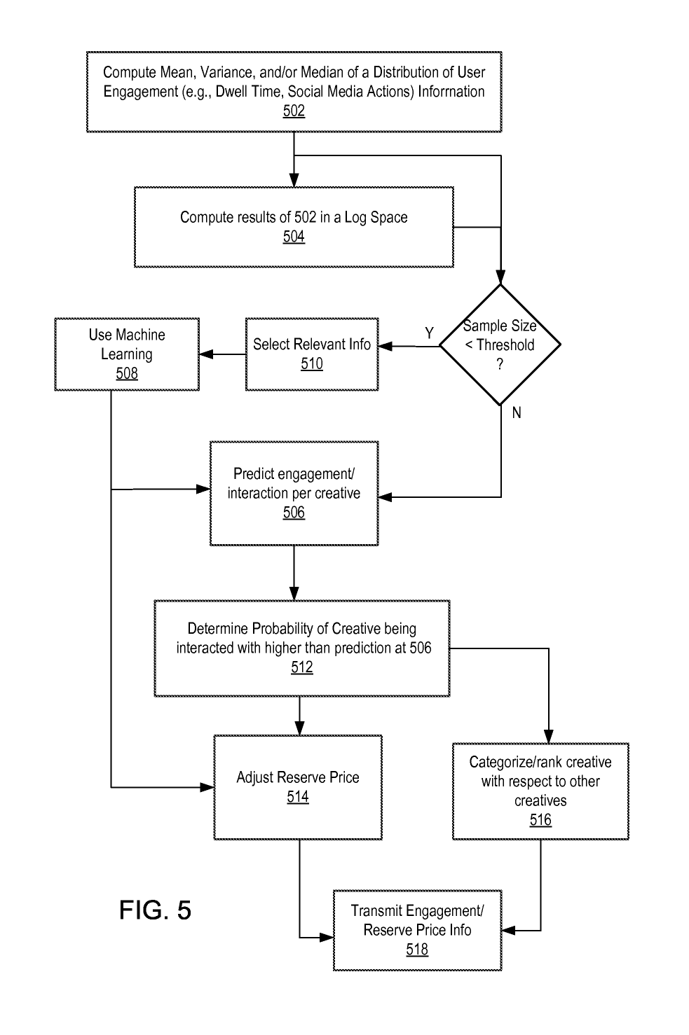

With further reference to FIG. 5, functionality of the statistical analyzer 306 and the reserve price adjuster 308 are disclosed in more detail. The statistical analyzer 306 can compute a mean, a variance, and/or a median of a dwell time and/or other engagement distribution for the creative using raw session data or preprocessed data focused on identifying user engagement information, at 502. Additionally or alternatively, the statistical analyzer 306 may compute a mean, variance, and median of the dwell time and/or other engagement distribution of the creative in a log space (such as LOG(dwell time)), at 504. This may facilitate each user engagement signal, such as an advertisement click or dwell time, being associated with measurable non-binary signals, such as graded labels or dwell time based scores. For example, user engagement levels can be divided into multiple grades or quantiles (such as a first quantile, a second quantile, etc.) of dwell times in a log space. The statistical analyzer 306 may then determine the engagement grade or quantile for an engagement. Grades or quantiles may be increased by using the integer part of log(dwell time) as the engagement level, for example.

In another example, real-time per creative dwell time mean and/or variance in a log space can be a approximated via systems and methods disclosed in “PRIORITIZING ITEMS FROM DIFFERENT CATEGORIES IN A NEWS STREAM,” (Atty. Dkt. 12729-1122) filed on Apr. 29, 2013, U.S. Ser. No. 13/872,436, now U.S. Pat. No. ______.

Also, the statistical analyzer 306 may predict an expected dwell time and/or other engagement associated with the creative, at 506. This is even the case where there is little to no historical click and/or dwell time information. Where there is little information, such as a sampling level that does not meet a threshold, the statistical analyzer 306 may use machine learning models trained on other relevant dwell time, other user interaction information, and/or attributes of the creative (such as ad length or ad category), at 508. The statistical analyzer 306 can also leverage advanced machine learning techniques and/or linear regression techniques to predict the expected dwell time for each new creative. Machine learning techniques may include gradient boosting decision trees and regression tools such as linear regression or logistic regressions, for example. The other historical click and/or dwell time information, or training data, can be selected from one or more similar creatives in order to improve the accuracy of the prediction at 506. Similarity between creatives may be determined through known methods, and in selection of the other relevant dwell time and/or user interaction information at 510, a threshold value may be predetermined with respect to the amount of similarity desired to filter out non-relevant information.

The statistical analyzer 306 may compute the probability of a creative being interacted with being higher than its predicted expected engagement (such as expected CTR and/or dwell time) according to Formulas 2 and 3, at 512. The probability of a creative being interacted with being higher than its predicted expected engagement can represent expected engagement for a creative relative to other similar creatives, for example.

z=(PEE−DTM)/DTV, (2)
wherein PEE is predicted expected engagement,
wherein DTM is real-time dwell time mean, and
wherein DTV is real-time dwell time variance.

P=1−phi(z)¹, (3)
wherein P is the probability of a creative being interacted with higher than its predicted expected engagement. ¹ https://en.wikipedia.org/wiki/Normal_distribution
   P or some function of P, e.g., f(P), where the function is linear or non-linear, can be used as a discounting factor for adjusting the reserve price. Where the P value is less than a significance threshold (e.g., 0.05, 0.1 or the like) for an advertisement, than the reserve price adjuster 308 may dynamically adjust higher the reserve price at 514, e.g., as RP*f(z) for the advertisement because its real-time performance shows poor user engagement. A similar approach may be taken at the campaign level, if desired.

The statistical analyzer 306 (and/or the reserve price adjuster 308) may also adjust the reserve price at 514 using the machine learning approach at 508. For example, the statistical analyzer 306 may use known machine learning techniques, such as gradient boosting decision trees to predict the eCPM, CTR and/or dwell time of a creative. CTR can be computed directly from a click signal. In general, user engagement signals can be used to further weight and/or adjust the reserve price, such as shown by Formula 4:

adjusted Reserve Price(RP)=f_engagement_to_RP(Sum(weight of click or other interaction)/impressions)*RP_{baseline}, (4)
wherein adjusted RP is an adjusted RP for a creative,
wherein f_engagement_to_RP is a linear/nonlinear mapping/function from user engagement signal level to the adjustment factor,
wherein RP_{baseline} is the baseline RP set by the publisher for showing an averagely engaging creative in one impression
wherein weight of click or other interaction=F(user engagement level),
wherein user engagement level is a measure of user interaction and/or engagement with a creative,
wherein Sum(weight of click or other interaction) is the sum of weights associated with different types of engagement and interaction associated with a creative, and
wherein impressions is an amount of impressions of the creative.

Also, the statistical analyzer 306 may use an online learning algorithm to update the CTR prediction model according to received user engagement signals, such as signals collected by the online activity collector 304. This can be done for each creative. This model and the others can continually receive real-time feedback from the online activity collector 304 and can adjust reserve price, according to such feedback. With time, the model should become more accurate due to more feedback over time. This concept of feedback also applies to the machine learning, at 508.

Another function of the statistical analyzer 306 may include to differentiate between engaging and ignored creatives at 516, e.g., to determine relative levels of engagement of a creative with respect to competing creatives, such as providing scores for ranking creatives competing for a bid (and/or reserve price) on a slot. Also, creatives with a low rank with respect to a threshold rank or competing creatives can have their respective reserve prices increased, and creatives with a high rank with respect to a threshold rank or competing creatives can have their respective reserve prices decreased. The aforementioned models can be combined in various ways to provide different results, and such combining can be automated. The statistical analyzer 306 may direct this automation of combining models, according to feedback received from the online activity collector 304 and/or the reserve price adjuster 308, for example.

Data associated with the adjusted reserve price and/or the rated creatives may then be transmitted to other components of system associated with the NGD pricing server 118, such as the reserve price adjuster 308 for price adjustment, at 518.

The reserve price adjuster 308 may include various price adjustment logic or components. As shown in FIG. 3, pricing information and user interaction information may be directed to one or more servers of a content exchange network 300 from the reserve price adjuster. For a creative or campaign, the reserve price adjuster 308 may also base reserve price on respective user engagement distribution, respective predicted expected user engagements, and other factors determined by the statistical analyzer 306. Exemplary determination and adjustment of reserve price can be done using any combination of models described herein, and can be performed by the reserve price adjuster 308.

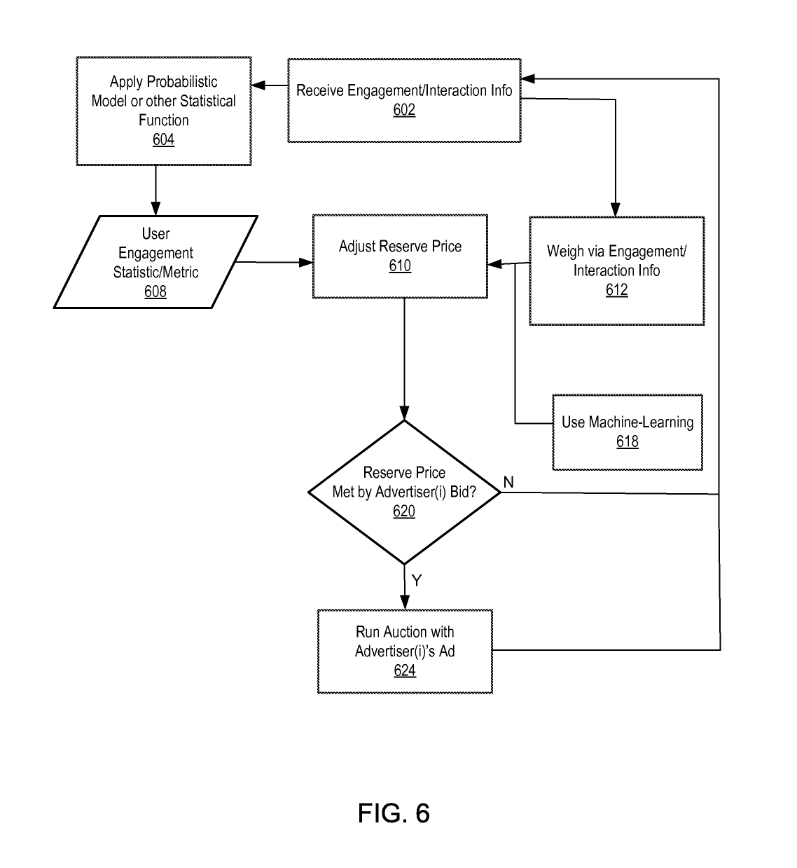

With further reference to FIG. 6, functionality of the statistical analyzer 306 and reserve price adjuster 308 is disclosed in more detail. At 602, the statistical analyzer 306 may receive the user interaction information, such as from the online activity collector 304. The statistical analyzer 306 may use the user interaction information to apply a probabilistic model (such as discussed with reference to FIG. 5) or other statistical function 604 to the user interaction (user engagement) information. The result of execution of the probabilistic (or other statistic) function or model is a user engagement statistic or metric for an identified advertisement among eligible advertisement for an auction.

Other statistical functions may include, for example, to determine a first mean user engagement for the advertisements eligible to fill an impression in an NGD spot market and determine a second mean user engagement for the identified advertisements. The value of the user engagement statistic may include a ratio of the first mean user engagement divided by the second mean user engagement. In this case, at 610, the reserve price adjuster 308 may multiply the reserve price by this ratio to set the adjusted reserve price for the identified advertisement, so that advertisements with shorter dwell time or lower level of user engagement can participate in the auction for the impression by paying higher reserve price.

For example, if the real-time engagement level of the identified advertisement is only e=½ of normal engagement level (where e is the user signal level), the reserve price (RP) may be adjusted to p=1/e*RP or to p=RP/(e*e) (or p=RP/f(e), where f is a function from the user engagement level to reserve price adjusting factor), depending on the negative impact degree of showing non-engaging advertisements on products of a publisher and how the publisher would like to adjust the reserve price for lower-engaging-level advertisement. Remember that p is the final adjusted reserve price for the impression.

In another statistical function example, the statistical analyzer 306 may generate a dwell time statistic based on ratios of short-click ratios. This statistical function may determine a first short-click ratio of the identified advertisement according to the dwell time information for the identified advertisement and a short-click threshold. The statistical function may further determine a second short-click ratio of the eligible advertisements according to the dwell time information and short-click threshold for the eligible advertisements, the second short-click ratio being an average short-click ratio for all the eligible advertisements. The value of the dwell time statistic may be a third ratio of the first short-click ratio divided by the second short-click ratio. In this example, at 610, the reserve price adjuster 308 may multiply the reserve price by the third ratio to set the adjusted reserve price for the identified advertisement.

Any of these models or statistical functions may be applied or experimented with to determine which one is optimal so that publishers meet an optimization goal, e.g., some target that can be specified by utility values including both revenue and user engagement. Or, machine learning may be used to effectuate long-term user engagement as the optimization goal to find the correct approach, e.g., by use of regression with these models and/or functions.

The reserve price adjuster 308 may also use user interaction information to weigh clicks or dwell times at 612. Using such a weight, the reserve price adjuster 308 can determine an adjusted reserve price based on different user engagement signals for each different creative, for example. The reserve price adjuster 308 can also use machine learning techniques, such as regression approaches and online learning approaches, to determine adjusted reserve price, at 618, so that the adjusted reserve price can be an input for auction execution based on bid prices and NGD contracts.

At 620, the NGD exchange server 130 may compare the reserve price with bids received from advertisers, to check whether each respective advertiser meets the reserve price. At 624, the NGD exchange server 130 may proceed with the NGD auction with advertisements from those advertisers that meet their individually (selectively) adjusted reserve price.

The reserve price adjuster 308 can use an adjusted reserve price for one or more creatives separately from other creatives that may be competing in an NGD auction for an impression, e.g., for an advertising display opportunity in a slot of a content stream. With this arrangement, the NGD pricing server 118 may automatically promote more engaging content and demote non-engaging content over time by influencing the outcome of the NGD auctions for impressions. Even creatives associated with a limited amount of session data can be promoted and demoted to a lesser degree. In other words, promotion and demotion of a creative can be based partially on the amount of historical data available associated with that creative. Less engaging creatives will have a lower probability of winning a slot opportunity in an auction. Also, by adjusting reserve price for less engaging creatives, publishers of the impression will take less risk in placing their creatives in streams and web pages.

The NGD pricing server 118 may also be useful when used with a unified market place stream and/or various social media streams. For example, the pricing server may be useful with “PRIORITIZING ITEMS FROM DIFFERENT CATEGORIES IN A NEWS STREAM,” (Atty. Dkt. 12729-1122) filed on Apr. 29, 2013, U.S. Ser. No. 13/872,436, now U.S. Pat. No. ______. The NGD pricing server 118 may reduce a publisher's risk of losing users long term when adjusting strategies for delivering content. The ability to adjust reserve price in a stream may be especially useful considering the high CTRs experienced in content stream environments.

In an example of how the disclosed system and methods could play out in an NGD auction, assume that publisher A sets the baseline reserve price (RP) to be $0.1. The system finds that campaign B bids on an engaging creative, thus the system does not adjust the RP and lets B have $0.1 as the RP. The system, however, finds that the creative bid on in campaign C is non-engaging or poorly engaging through the disclosed dwell-time or engagement-based analysis.

Accordingly, the system may set an adjustment factor (applied statistic) to be 4 (four) and the final RP for C is adjusted to $0.4. Now, consider these three different cases during the auction: (1) if B wins the auction with a $0.5 bid and if C bids $0.05, according to second-price auction rule, B pays $0.1 (note that RP also takes part in this auction); (2) if C wins the auction with a $0.5 bid, and if B bids $0.3, C still needs to pay $0.4 according to the second-price auction rule and C's RP is $0.4; and (3) if B does not participate in the auction because B runs out of budget while C only bids $0.1 for the slot, C is excluded from the auction because this price is lower than its $0.4 RP. Thus, from the above three cases, the approach effectively protects publisher A from non-engaging advertisements from winning the auction with the same cost as engaging advertisements, and/or from winning with little cost in the auction where there is less competition.

By giving different reserve prices to different advertisers, campaigns, and/or creatives, the ad exchange system can help publishers to achieve the goal of generating healthy short-term, but also long-term revenue. Using this approach, advertisers are encouraged to generate highly engaging advertisements in order to win impression opportunity with less cost, and low quality advertisements will either have to pay a high cost to win a auction or fail to reach the reserve price, and thus not participate in the auction.

Accordingly, publishers may reduce the risk of losing users long term when making profit using stream advertisements (such as product-related stream ads, twitter stream ads, Facebook stream ads, or other stream advertisements on mobile/tablet devices). The reason is because stream advertisements look similar to other content items (creatives) in the content stream, and the stream advertisements have more of a direct impact on publishers' user experience than the traditional display ads on web pages. The present disclosure introduces a defense system that considers user's long term engagement impact into the floor price setting for publishers, when trying to recover the short-term business cost by adjusting reserve prices for advertisements and/or campaigns.

The present disclosure also better protects publishers from non-engaging ad campaigns that may try to game the system in showing their non-engaging advertisements (for example, by adopting “bid less, bid more” strategy) in order to win auctions when higher engaging advertisements cannot participate. Non-engaging advertisements, therefore, will have a higher bar to enter the auctions and to win those auctions where there is less competition.

The present disclosure's system design can be directly integrated into the current existing ad exchange systems, and the implementation cost is low when compared with other approaches of using user engagement signals by revising the NGD contract, for example. Additional benefits include, but are not limited to: (1) the NGD pricing server 118 can quickly discover highly engaging advertisements and low engaging advertisements during short random exploration time period; and (2) the reserve price of the advertisements may be automatically and dynamically adjusted in the ad exchange system.

It is intended that the foregoing detailed description be regarded as illustrative rather than limiting, and that it be understood that it is the following claims, including all equivalents, that are intended to define the spirit and scope of this disclosure. Furthermore, the separating of example operation blocks or modules described herein or illustrated in the drawings is not to be construed as limiting these blocks or modules as physically separate devices. Also, each module or operation block described herein may include either computer hardware or a combination of computer hardware and software. For example, each module may include a non-transitory computer readable medium including executable instructions, such as any type of programmable circuit. A programmable circuit may include an application specific integrated circuit (ASIC) and/or a Field Programmable Gate Array (FPGA), for example. Additionally, each module may include memory hardware to store instructions executable by a processor, such as a central processing unit (CPU). Additionally, each module may transmit or receive data by a respective communications interface. The data may be transmitted and received via a network, such as or including the Internet.

1. A system comprising:
a processor configured to:
retrieve a reserve price set by a publisher for an impression that is fillable by eligible advertisements to be streamed to users in a display content stream;
retrieve user engagement information for users that engage the eligible advertisements;
a statistical analyzer executable by the processor to apply a statistical function to the user engagement information of an identified advertisement of the eligible advertisements, to generate a user engagement statistic for the identified advertisement related to a user engagement level; and
a reserve price adjuster configured to dynamically adjust the reserve price for the identified advertisement responsive to a value of the user engagement statistic, where the adjusted reserve price for the identified advertisement is different than the reserve price for at least another of the eligible advertisements.

2. The system of claim 1, where the reserve price and the adjusted reserve price influence the outcome of a non-guaranteed delivery (NGD) auction, and where the user engagement information relates to user engagement selected from the group consisting of dwell time, clicks, shares, likes and tweets.

3. The system of claim 1, where to apply the statistical function, the statistical analyzer is configured to:
determine a mean of user engagement of the eligible advertisements;
predict an expected user engagement of the identified advertisement according to the variance from the mean reflected in the user engagement information for the identified advertisement; and
determine a probability that the actual user engagement of the identified advertisement will exceed the expected user engagement, where the probability comprises the user engagement statistic.

4. The system of claim 3, where the statistical analyzer is further configured to determine a z-value comprising a difference between the expected user engagement and the mean divided by the variance; and where the bid reserve price adjuster is further configured to:
determine whether the probability is less than a significance threshold; and
set the reserve price higher according to a function of the z-value when the probability is less than the significance threshold and the z-value is positive.

5. The system of claim 1, where to apply the statistical function, the statistical analyzer is configured to:
determine a first mean user engagement for the eligible advertisements;
determine a second mean user engagement for the identified advertisement;
where the value of the user engagement statistic comprises a ratio of the first mean user engagement divided by the second mean user engagement; and
where the bid reserve price adjuster is further configured to multiply the reserve price by the ratio to set the adjusted reserve price for the identified advertisement.

6. The system of claim 1, where to apply the statistical function, the statistical analyzer is configured to:
determine a first short-click ratio of the identified advertisement according to the user engagement information for the identified advertisement and a short-click threshold;
determine a second short-click ratio of the eligible advertisements according to the user engagement information and short-click threshold for the eligible advertisements, the second short-click ratio being an average short-click ratio for all the eligible advertisements;
where the value of the user engagement statistic comprises a third ratio of the first short-click ratio divided by the second short-click ratio; and
where the reserve price adjuster is further configured to multiply the reserve price by the third ratio to set the adjusted reserve price for the identified advertisement.

7. The system of claim 1, where the user engagement statistic comprises average user engagement, where the average user engagement for the identified advertisement is determined via a statistical analysis selected from the group consisting of a mean, a variance and a median of user engagement distribution of the identified advertisement with respect to the eligible advertisements.

8. A method executable by a computer having a processor and memory, comprising:
retrieving, by the processor, a reserve price set by a publisher for an impression that is fillable by eligible advertisements to be streamed to users in a display content stream;
retrieving, by the processor, user engagement information for users that engage retrieve user engagement information for users that engage the eligible advertisements;
applying, by the processor, a statistical function to the user engagement information of an identified advertisement of the eligible advertisements, to generate a user engagement statistic for the identified advertisement related to a user engagement level; and
dynamically and selectively adjusting, by the processor, the reserve price for the identified advertisement responsive to a value of the user engagement statistic, where the adjusted reserve price for the identified advertisement is different than the reserve price for at least another of the eligible advertisements for an auction conducted by an exchange server.

9. The method of claim 8, further comprising:
applying the statistical function to the user engagement information of others of the eligible advertisements, to generate user engagement statistics for respective of a plurality of the eligible advertisements; and
dynamically and selectively adjusting the reserve price for each of the plurality of the eligible advertisements responsive to values of respective user engagement statistics.

10. The method of claim 9, where the reserve price and the adjusted reserve prices influence the outcome of a non-guaranteed delivery (NGD) auction, and where the user engagement information relates to user engagement selected from the group consisting of dwell time, clicks, shares, likes and tweets.

11. The method of claim 8, where in applying the statistical function, the method further comprising:
determining a mean of user engagement of the eligible advertisements;
predicting an expected user engagement of the identified advertisement according to the variance from the mean reflected in the user engagement information for the identified advertisement; and
determining a probability that the actual user engagement of the identified advertisement will exceed the expected user engagement, where the probability comprises the user engagement statistic.

12. The method of claim 11, further comprising:
determining a z-value comprising a difference between the expected user engagement and the mean divided by the variance;
determining whether the probability is less than a significance threshold; and
setting the reserve price higher according to a function of the z-value when the probability is less than the significance threshold and the z-value is positive.

13. The method of claim 8, further comprising:
determining a first mean user engagement for the eligible advertisements;
determining a second mean user engagement for the identified advertisement;
where the value of the user engagement statistic comprises a ratio of the first mean user engagement divided by the second mean user engagement; and
multiplying the reserve price by the ratio to set the adjusted reserve price for the identified advertisement.

14. The method of claim 8, further comprising:
determining a first short-click ratio of the identified advertisement according to the user engagement information for the identified advertisement and a short-click threshold;
determining a second short-click ratio of the eligible advertisements according to the user engagement information and short-click threshold for the eligible advertisements, the second short-click ratio being an average short-click ratio for all the eligible advertisements;
where the value of the user engagement statistic comprises a third ratio of the first short-click ratio divided by the second short-click ratio; and
multiplying the reserve price by the third ratio to set the adjusted reserve price for the identified advertisement.

15. A non-transitory computer-readable storage medium comprising computer-executable instructions that, when executed by a computer having a processor and memory, perform reserve price adjusting for advertisements of non-guaranteed delivery (“NGD”) advertising auctions, by:
retrieving, by the processor, a reserve price set by a publisher for an impression that is fillable by eligible advertisements to be streamed to users in a display content stream;
retrieving, by the processor, user engagement information for users that engage retrieve user engagement information for users that engage the eligible advertisements;
applying, by the processor, a statistical function to the user engagement information of an identified advertisement of the eligible advertisements, to generate a user engagement statistic for the identified advertisement related to a user engagement level; and
dynamically adjusting, by the processor, the reserve price for the identified advertisement responsive to a value of the user engagement statistic, where the adjusted reserve price for the identified advertisement is different than the reserve price for at least another of the eligible advertisements for an auction conducted by an exchange server.

16. The non-transitory computer-readable storage medium of claim 15, further comprising instructions executable by the processor for:
applying the statistical function to the user engagement information of others of the eligible advertisements, to generate user engagement statistics for respective of a plurality of the eligible advertisements; and
dynamically and selectively adjusting the reserve price for each of the plurality of the eligible advertisements responsive to values of respective user engagement statistics.

17. The non-transitory computer-readable storage medium of claim 15, where in applying the statistical function, further comprising instructions executable by the processor for:
determining a mean of user engagement of the eligible advertisements;
predicting an expected user engagement of the identified advertisement according to the variance from the mean reflected in the user engagement information for the identified advertisement; and
determining a probability that the actual user engagement of the identified advertisement will exceed the expected user engagement, where the probability comprises the user engagement statistic.

18. The non-transitory computer-readable storage medium of claim 15, further comprising instructions executable by the processor for:
determining a z-value comprising a difference between the expected user engagement and the mean divided by the variance;
determining whether the probability is less than a significance threshold; and
setting the reserve price higher according to a function of the z-value when the probability is less than the significance threshold and the z-value is positive.

19. The non-transitory computer-readable storage medium of claim 18, further comprising instructions executable by the processor for:
determining a first mean user engagement for the eligible advertisements;
determining a second mean user engagement for the identified advertisement;
where the value of the user engagement statistic comprises a ratio of the first mean user engagement divided by the second mean user engagement; and
multiplying the reserve price by the ratio to set the adjusted reserve price for the identified advertisement.

20. The non-transitory computer-readable storage medium of claim 18, further comprising instructions executable by the processor for:
determining a first short-click ratio of the identified advertisement according to the user engagement information for the identified advertisement and a short-click threshold;
determining a second short-click ratio of the eligible advertisements according to the user engagement information and short-click threshold for the eligible advertisements, the second short-click ratio being an average short-click ratio for all the eligible advertisements;
where the value of the user engagement statistic comprises a third ratio of the first short-click ratio divided by the second short-click ratio; and
multiplying the reserve price by the third ratio to set the adjusted reserve price for the identified advertisement.
